(19) United States
(12) Patent Application Publication
(10) Pub. No.: US 2008/0228950 A1
(43) Pub. Date: Sep. 18, 2008

(54) MEMORY POWER DOWN MODE EXIT METHOD AND SYSTEM

(75) Inventors: Margaret Clark Freebern, Richmond, VT (US); Farrukh Aquil, South Burlington, VT (US); Wolfgang Hokenmaier, Burlington, VT (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Qimonda North America Corp., Cary, NC (US)

(21) Appl. No.: 11/686,067

(22) Filed: Mar. 14, 2007

(51) Int. Cl. G06F 3/00

(52) U.S. Cl. 710/5

(57) ABSTRACT

A memory includes a circuit having a set terminal for receiving an input signal indicating a request to exit a power-down mode. The circuit is configured to provide an output signal to enable exiting the power-down mode in response to the input signal before the input signal is latched.

### BACKGROUND

In general, a dynamic random access memory (DRAM) device includes memory cells arranged in rows and columns in an array, with the rows extending along a row direction and the columns extending along a column direction. Conductive word lines extend across the array of memory cells along the row direction and conductive bit lines extend across the array of memory cells along the column direction. A memory cell is located at each cross point of a word line and a bit line. Memory cells are accessed using a row address and a column address.

DRAM memory cells are essentially made up of a capacitor, and data are stored in the DRAM memory cells in the form of electric charges. Data retention time is therefore limited, since over time a stored charge gradually leaks off. To prevent data corruption, the charge must be periodically refreshed. To refresh data in a memory array, data is obtained from a row of memory cells, and subsequently, these data are used as new input data that is re-written to the memory cells, thus maintaining the stored data.

DRAMs have several modes designed to reduce current consumption while the memory device is not being used. For example, power-down mode is a low-power state of a DRAM during which no accesses may occur. Command, address and data receivers, data drivers, and some generators are disabled. Power-down mode is entered by bringing a clock enable (CKE) signal low and holding it low for the duration of the power-down. Typically, at least one rising clock edge must occur to latch the low CKE signal. During the power-down, the clock may continue to oscillate or may be held stable. In known memory systems, exit from power-down occurs when the CKE signal is brought back high and then latched with a rising clock edge. Following the rising edge of CKE, the DRAM controller must wait for a predetermined time period—the power-down exit delay time (tXP)—to expire before issuing another command. The delay time is sometimes expressed as a predetermined time period, such as 200 nanoseconds, or a predetermined number of clock cycles, such as two clock cycles.

In some DRAM applications, a power-down exit delay time tXP of just one clock cycle is desirable. Thus, when CKE rises a setup time before a rising clock edge, the next rising clock edge must be available to latch a new command.

For these and other reasons, there is a need for the present invention.

### SUMMARY

In accordance with an embodiment of the present invention, a memory includes a circuit having an input terminal for receiving an input signal indicating a request to exit a power-down mode. The circuit is configured to provide an output signal to enable exiting the power-down mode in response to the input signal before the input signal is latched.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a block diagram conceptually illustrating a system in accordance with embodiments of the present invention.

FIG. 2 is a block diagram illustrating circuit in accordance with an exemplary embodiment of the present invention.

FIG. 3 is a timing diagram illustrating the timing of selected signals associated with exiting a power-down mode of a memory.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

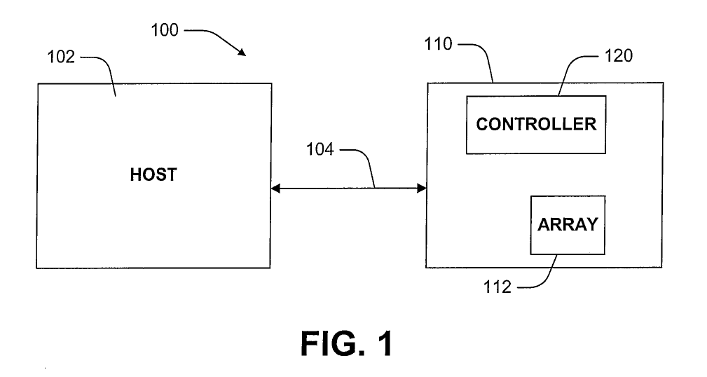

FIG. 1 is a block diagram illustrating an exemplary embodiment of a memory system 100. The memory system 100 includes a host 102 and a memory 110. The memory 110 comprises a random access memory (RAM), such as a dynamic random access memory (DRAM), a synchronous dynamic random access memory (SDRAM), a double data rate synchronous dynamic random access memory (DDR-SDRAM), a low power SDRAM (e.g., MOBILE-RAM), or another suitable memory. The host 102 is electrically coupled to the memory 110 through a memory communication path 104. The memory 110 includes a memory array 112 of memory cells and a controller 120 that controls detailed operations of memory 110 such as the various individual steps necessary for carrying out data writing, reading, and refresh operations.

The host 102 includes logic, firmware, and/or software for controlling the operation of the memory 110. In one embodiment, the host 102 is a microprocessor or other suitable device capable of passing a clock signal, address signals, command signals, and data signals to the memory 110 though the memory communication path 104 for reading data from and writing data to the memory 110. The controller 120 controls, among other things, communications with the host 102 through the memory communication path 104, and reading and writing data in the memory array 112. The memory 110 responds to memory read requests from the host 102 and passes the requested data to the host 102. The memory 110 responds to write requests from the host 102 and stores data in the memory array 112 passed from the host 102.

The controller 120 further controls power-down operations for the memory 110. Power-down mode may be entered when the memory 110 is either idle with all banks in the memory array 112 precharged, or when the memory 110 is active with at least one bank of the memory array 112 open for accesses. These modes are referred to as precharge power-down and active power-down, respectively. This specification does not distinguish between the two; they are collectively referred to as power-down.

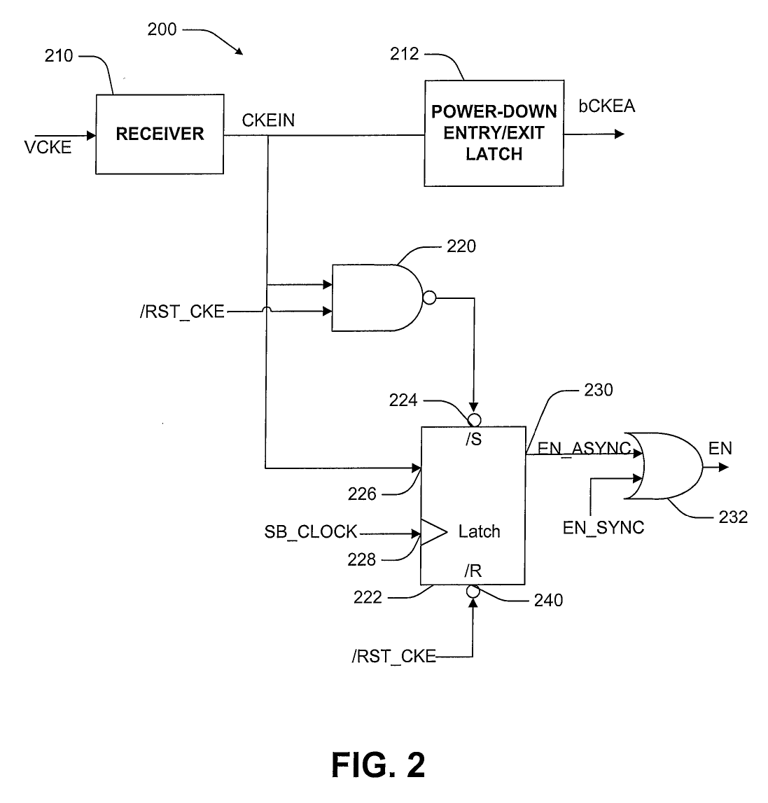

FIG. 2 is a block diagram illustrating portions of a circuit 200 for exiting a power-down mode. A receiver 210 has an input terminal receiving a clock enable (VCKE) signal indicating a request to exit the power-down mode. In the illustrated embodiment, the VCKE signal is brought and held high for at least some predetermined time period to signal a request to exit the power-down mode. The receiver outputs a CKEIN signal that is provided to a power-down entry and exit latch 212, which outputs a bCKEA signal indicating detection of a latched power-down entry or exit signal.

The power-down entry and exit latch 212 provides compatibility with systems using a power-down exit delay time tXP of two clock cycles. Previous implementations of power-down exit involved latching the high CKE signal and re-enabling the disabled portions of the memory. In some situations, it is desirable to reduce the power-down exit delay time tXP to only one clock cycle. With such a reduced power-down exit delay time, the rising clock edge immediately following receipt of the VCKE signal must be available to latch a new command.

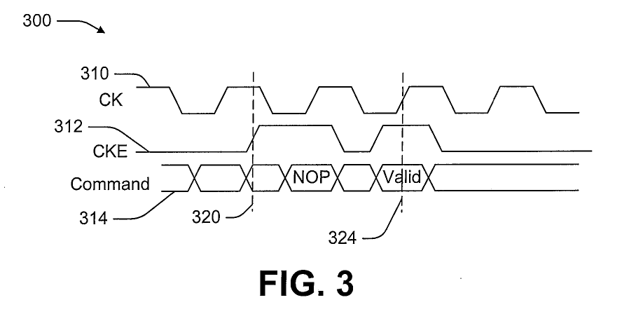

FIG. 3 illustrates a portion of a timing diagram 300 for a memory system having a power-down exit delay time tXP of one clock cycle. The timing diagram 300 includes a clock (CK) signal 310, a clock enable (CKE) signal 312 and a command signal 314. The rising CKE signal 312 signals the exit from power-down mode, indicated at 320. As shown in FIG. 3, the CKE signal 312 is rising a setup time before a rising edge of the clock signal 310. The next rising edge 322 of the clock signal 312 is available to latch a new command.

At high frequencies or low clock high time, however, a clock glitch can be created that interferes with latching the command 314 on the next cycle 322. Moreover, in existing systems that require latching a high CKE signal to detect the power-down exit, it is possible that the path to latch the high CKE signal to the point where command, address, and data mask receivers are enabled takes longer than one clock cycle. In this case, the inputs provided at the next clock cycle would not be properly received and latched. If the normal differential clock receiver is disabled during power-down mode and a lower power standby clock receiver is used to latch the high CKE signal instead, the normal differential clock receiver will need to be re-enabled before the next clock cycle. It is possible that this path is too slow and that the next rising clock edge will be unstable, delayed, or subject to glitches. Still further, in some systems the master clock is driven by a standby clock receiver during power-down, and by a differential clock receiver during normal operation. Transitioning between these clocks during exit from power-down could create a glitch on the master clock.

The circuit 200 illustrated in FIG. 2 is configured to provide an output signal EN_ASYNC that enables exiting the power-down mode before the VCKE input signal is latched. The EN_ASYNC signal creates a receiver enable signal EN that allows portions of the memory 110, such as the differential clock, command, address and data mask receivers, to turn on as soon as possible after the VCKE signal goes high.

The received and unlatched VCKE signal (CKEIN) is connected to one input of a NAND gate 220, the output of which is connected to an asynchronous set terminal 224 of a latch 222, such that a rising VCKE input signal sets the EN_ASYNC signal at the output 230 of the latch 222 high asynchronously. The EN_ASYNC signal is received by one input of an OR gate 232, which in turn outputs an enable signal (EN).

The received and unlatched CKE signal input (CKEIN) signal output by the receiver 210 is also connected to an input 226 of the latch 222, and a standby clock (SB_CLK) signal is received by a latch input 228 of the latch 222, such that the CKE input signal is latched with the next rising edge of the standby clock. This provides glitch protection in the case where the CKEIN signal has a positive glitch, causing the EN_ASYNC output to mistakenly go high in response. On the next rising edge of the standby clock, however, the CKEIN signal will have returned low. The low CKEIN signal is latched by the SB_CLK signal received at the latch input 228, and properly turns EN_ASYNC off, thus returning the memory 110 to its power-down state.

An active low reset CKE (/RST_CKE) signal is connected to a second input of the NAND gate 220 and also to an active low reset terminal 240 of the latch 222. The /RST_CKE signal is used to selectively disable the output of the EN_ASYNC signal by the circuit 200 that would otherwise occur in response to the rising VCKE signal. During normal power-down operations, the /RST_CKE signal is high. When this signal is brought low the active low reset 240 of the latch 222 sets the EN_ASYC signal at the output 230 of the latch 222 low, which disables the receivers. The NAND gate 220 controls the active low set 224 of the latch 222 so that when the EN_ASYC signal is low, the active low set 224 of the latch 222 is held low. In this manner, the CKEIN signal is blocked from asynchronously setting the latch 222. This is useful during certain testing modes, for example.

A synchronous receiver enable (EN_SYNC) signal is received by the other input of the OR gate 232. The EN_SYNC signal may be derived from the output of the power-down entry and exit latch 212 because the EN_SYNC signal represents the synchronous power-down exit that is detected by the power-down entry and ext latch 212. This signal existed in prior systems where the power-down exit delay time tXP was two clock cycles. The EN_SYNC signal is combined with the EN_ASYNC signal to allow a power-down exit synchronously when the /RST_CKE signal is used to disable the EN_ASYNC output.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A memory controller, comprising:
a circuit having a set terminal for receiving an input signal indicating a request to exit a power-down mode; and
the circuit being configured to provide an output signal to enable exiting the power-down mode in response to the input signal, before the input signal is latched.

2. The memory controller of claim 1, wherein the circuit includes a latch input for receiving a clock signal.

3. The memory controller of claim 2, wherein the circuit further includes an input terminal for receiving the input signal.

4. The memory controller of claim 3, wherein the circuit is configured to provide the output signal in response to an edge trigger of the input signal.

5. The memory controller of claim 3, wherein the circuit is configured to terminate the output signal in response to a change in a logic level of the input signal.

6. The memory controller of claim 1, wherein the circuit includes a disable terminal for receiving a disable signal, wherein the circuit is disabled in response to receiving the disable signal.

7. The memory controller of claim 1, wherein the circuit includes a latch, and wherein the set terminal is an asynchronous set terminal of the latch.

8. A memory device, comprising:
a memory array;
a memory controller including a circuit having a set terminal for receiving an input signal indicating a request to exit a power-down mode; and
the circuit being configured to provide an output signal to enable exiting the power-down mode in response to the input signal, before the input signal is latched.

9. The memory device of claim 8, wherein the circuit includes a latch input for receiving a clock signal.

10. The memory device of claim 9, wherein the circuit further includes an input terminal for receiving the input signal.

11. The memory device of claim 10, wherein the circuit is configured to provide the output signal in response to an edge trigger of the input signal.

12. The memory device of claim 10, wherein the circuit is configured to terminate the output signal in response to a change in a logic level of the input signal.

13. The memory device of claim 8, wherein the circuit includes a disable terminal for receiving a disable signal, wherein the circuit is disabled in response to receiving the disable signal.

14. The memory device of claim 8, wherein the circuit includes a latch, and wherein the set terminal is an asynchronous set terminal of the latch.

15. A memory device, comprising:
means for storing data; and
means for exiting a power-down mode asynchronously.

16. The memory device of claim 15, wherein the means for exiting includes means for latching an input signal requesting the exit from power-down mode.

17. The memory device of claim 15, wherein the means for exiting outputs an enable signal, and wherein the means for exiting includes means for cancelling the enable signal in response to a glitch.

18. The memory device of claim 15, further comprising means for disabling the means for exiting.

19. A system, comprising:
a host device;
a memory array connected to the host device;
a memory controller including a circuit having a set terminal for receiving an input signal indicating a request to exit a power-down mode; and
the circuit being configured to provide an output signal to enable exiting the power-down mode in response to the input signal, before the input signal is latched.

20. The system of claim 19, wherein the circuit includes a latch input for receiving a clock signal.

21. The system of claim 20, wherein the circuit further includes an input terminal for receiving the input signal.

22. The system of claim 21, wherein the circuit is configured to provide the output signal in response to an edge trigger of the input signal.

23. The system of claim 21, wherein the circuit is configured to terminate the output signal in response to a change in a logic level of the input signal.

24. The system of claim 19, wherein the circuit includes a disable terminal for receiving a disable signal, wherein the circuit is disabled in response to receiving the disable signal.

25. The system of claim 19, wherein the circuit includes a latch, and wherein the set terminal is an asynchronous set terminal of the latch.

26. A method of operating a memory device, comprising:
receiving an input signal indicating a request to exit a power-down mode; and
outputting an enable signal in response to the input signal, wherein the enable signal is output before latching the input signal.

27. The method of claim 26, further comprising exiting the power-down mode in response to the enable signal.

28. The method of claim 26, wherein enable signal is generated asynchronously.

29. The method of claim 26, further comprising latching the input signal.

30. The method of claim 26, further comprising generating a clock signal, wherein the enable signal is output within one clock cycle after receiving the input signal.

31. The method of claim 26, further comprising terminating the enable signal in response to a glitch on the input signal.

32. A method of operating a memory device, comprising:
receiving an input signal indicating a request to exit a power-down mode; and
outputting an enable signal in response to the input signal, wherein the enable signal is output asynchronously.

33. The method of claim 32, further comprising exiting the power-down mode in response to the enable signal.

34. The method of claim 32, further comprising latching the input signal after generating the enable signal.

35. The method of claim 32, further comprising generating a clock signal, wherein the enable signal is output within one clock cycle after receiving the input signal.

36. The method of claim 32, further comprising terminating the enable signal in response to a glitch on the input signal.
